(19) United States
(12) Patent Application Publication
(10) Pub. No.: US 2016/0096360 A1
(43) Pub. Date: Apr. 7, 2016

(54) INK SUPPLY SYSTEMS FOR PRINTING PRESSES

(71) Applicant: Georgia-Pacific Corrugated LLC, Atlanta, GA (US)

(72) Inventors: Amy E. Zetzl, Hagerstown, IN (US); Michel F. Gross, Marietta, GA (US)

(21) Appl. No.: 14/508,761

(22) Filed: Oct. 7, 2014

(51) Int. Cl. B41F 31/02

(52) U.S. Cl. CPC B41F 31/02

(57) ABSTRACT

The invention disclosed herein relates to apparatus, systems and associated methods for supplying ink to printing presses. The ink supply systems operate in combination with a printing system and comprise a bulk ink supply system and a supplemental ink supply system. The bulk ink supply system and supplemental ink supply system can jointly, or individually, supply inks of different colors to individual press units of a printing press. The bulk ink supply system includes one or more supply lines leading to the printing press for supplying ink to the printing press in bulk. The supplemental ink supply system includes one or more ink canisters for supplying ink to the printing press. An intermediate ink supply system may be operated in addition to and/or in place of the bulk and/or supplemental ink supply system.

### FIELD

The invention disclosed herein relates to apparatus, systems and associated methods for supplying ink to printing presses.

### BACKGROUND

In the field of printing presses, one or more inks are printed in a continuous fashion onto a substrate, such as paper or paperboard. Several different printing methods are known in the art, including flexographic printing and offset printing.

Flexographic printing processes use a flexible relief plate supplied with a relatively low viscosity ink to form an image on the substrate. Offset, or lithographic, printing uses the repulsion of oil and water to create an image on the substrate. The substrate can be fed to flexographic or offset printing presses using either a sheet-fed process, whereby individual sheets of substrate are fed to the printing press, or a web-fed process, whereby a continuous web of substrate is fed to the printing press. A web-fed printing process is efficient, for example, in commercial applications, such as printing newspapers and books where high speed and long printing runs are common.

One aspect of a printing press is the supply system for the inks to be used. Indeed, in commercial offset printing, the inks are supplied in bulk form from supply lines leading to the printing press, with one supply line required for each color of ink. This limits the number of colors available to the printing press because changing the ink color for the supply line would require the time and expense of flushing the relatively long supply line to clean out the old ink color before the new ink color could be supplied. As such, a conventional ink supply system for offset presses uses only four colors; black, cyan, magenta and yellow (known in the art as the “KCMY” colors). The printing press includes a succession of printing units that apply these colors sequentially to the substrate to form the final image. As will be understood, however, the final image is constrained to a subset of possible colors based on the combination of the four KCMY colors.

On the other hand, in packaging printing it is desirable to be able to create specialty colors that may not be readily obtainable from a combination of the KCMY colors. For example, colors associated with a commercial brand of a company are often customized and very precisely controlled. These types of specialty colors are sometimes printed using a canister-type ink supply system. In a canister ink supply system, a canister is mounted above the printing press and ink is dispensed from the canister into the printing press. The canister may move along a carriage above the printing press ink fountain when dispensing ink. Once a canister is depleted of ink, it must be replaced with a new full canister. The ink for the canisters can be made in a specialty color in an offsite facility, and then multiple canisters supplied to the printing press location. However, a disadvantage with the canister ink supply system is that typically only one canister is used for each press unit of a printing press and the canisters are replaced manually as they are depleted, and thus the amount of ink that can be dispensed (and thus the throughput of the printing press) is limited.

Therefore, there is a need in the art for apparatus, systems and associated methods for supplying ink to printing presses that allow for high throughput for the printing press, but that simultaneously facilitate the use of specialty colors.

### SUMMARY

The present invention provides apparatus, systems and associated methods for supplying ink to a printing press and can include a bulk ink supply system, a supplemental ink supply system and an intermediate ink supply system.

The bulk ink supply system comprises one or more supply lines leading to the printing press for supplying ink to the printing press in bulk and wherein each of the supply lines supplies a single ink color such as black, cyan, magenta or yellow ink colors. The bulk ink supply system can further comprise a connection line for supplying ink from at least one of the supply lines to the printing press, and wherein the connection line can comprise a flexible hose.

The supplemental ink supply system comprises one or more ink canisters for supplying ink to the printing press, and a frame on which one or more ink canisters are mounted. In embodiments of the invention, one or more printing press units of the printing press can be provided with a supplemental ink supply system, and each supplemental ink supply system can comprise a plurality of ink canisters that supply ink of the same color to the at least one press unit. The ink canisters may supply ink of a color other than black, cyan, magenta or yellow.

An ink supply system may comprise a plurality of dispense systems associated with one or more of the ink canisters. Each dispense system comprises an actuator causing ink to be selectively dispensed from an associated ink canister when the actuator is actuated, a depletion sensor for sending a signal indicative of when the ink in the ink canister is at least partially depleted and a controller in operative communication with the dispense systems and adapted for causing at least one actuator to dispense ink from a subsequent one or more of the ink canisters when the depletion sensor sends a signal that the ink in a preceding ink canister is at least partially depleted. At least one of the dispense systems actuators comprises a supply of pressurized air. The ink supply system can further comprise a fill sensor for sending a signal indicative of the amount of ink available for use with a printing press unit. The ink supply system can further comprise at least one support for supporting the ink canisters, wherein the support is structured to allow a depleted canister to be removed from the support and be replaced with a new ink canister

The intermediate ink supply system comprised one or more barrels for supplying ink to the printing press. The intermediate ink supply system may comprise a dispense system associated with each barrel and the dispense system comprise a pump causing ink to be selectively dispensed from an associated barrel. According to embodiments of the invention, the pump may be a peristaltic pump.

Associated methods are also provided.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is side view of a printing press of the type that may be used with the ink supply systems according to embodiments of the invention;

FIG. 2 is an enlarged view of a portion of FIG. 1 illustrating two press units of the printing press;

FIG. 3 is an end view of a press unit and illustrating the ink supply systems according to embodiments of the invention;

FIG. 4 is an enlarged side view of a supplemental ink supply system according to embodiments of the invention;

FIG. 5 is a cross-sectional view illustrating a press unit, components of the bulk ink supply system, supplemental ink supply system, and intermediate ink supply system; and

FIG. 6 is a perspective view of a portion of a press and components of the bulk, supplemental, and intermediate ink supply systems.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### Overview

The ink supply systems according to various embodiments of the invention is illustrated in the figures in combination with a printing system 100 and comprise a bulk ink supply system 200, a supplemental ink supply system 300 and an intermediate ink supply system 500. The bulk ink supply system 200, supplemental ink supply system 300 and intermediate ink supply system 500 can jointly, or individually, supply inks of different colors to individual press units 122 of a printing press 120.

### Printing System 100

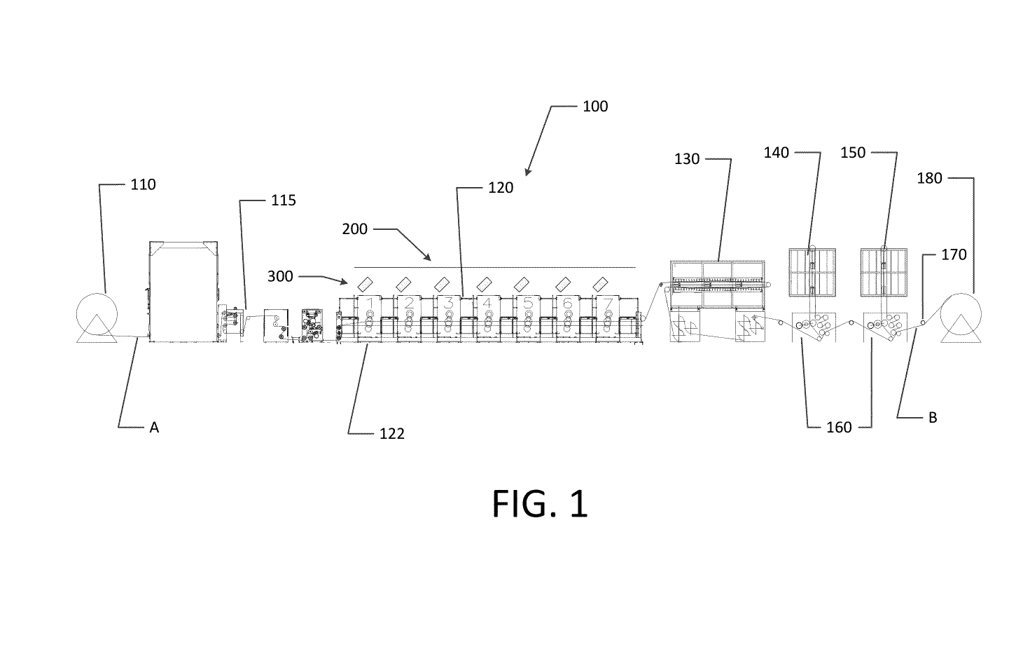

Various embodiments of the present invention comprise a printing system 100. FIG. 1 illustrates an example embodiment of an offset printing system 100, although various embodiments of the invention could be used with other types of printing systems including flexographic printing presses. Starting from the left side of FIG. 1, an unprinted substrate A is fed into the printing system 100 via web feeding device 110. The substrate could be any substrate suitable for printing including various grades of paper, paperboard, film, and the like. In various embodiments, the substrate A may be linerboard, medium, and/or the like for use in a subsequent high-speed corrugation process. For example, the substrate A may be a linerboard with a basis weight of approximately 23-55 pounds per 1000 square feet and a caliper of 0.007″-0.020″. The substrate caliper may range, for example, from about 0.004″-0.024″. In some embodiments, such as the embodiment illustrated in FIG. 1, infeed equipment 115 may be configured to control the tension in the unprinted substrate A. Some embodiments may not comprise infeed equipment 115 and the tension in the substrate A may be controlled via other mechanisms or methods. The unprinted substrate A is then fed to a printing press 120.

In the example embodiment illustrated in FIG. 1, the printing press 120 is a variable sleeve wide-web offset press, such as the Sunday Vpak 3000 by Goss International. This printing press 120 allows for printing at different repeat lengths up to, for example, 55 inches, although other dimensions could be used. By varying the thickness of the print sleeve, the circumference of the printing cylinder may be changed, and therefore the repeat length may be changed to accommodate various printing jobs. The variable repeat length allows the same press to be used for the printing of, for example, boxes of different sizes. In the embodiment illustrated in FIG. 1, seven press units 122 are used to apply various colors or layers of ink to the substrate A as discussed below to create a printed substrate B. In various embodiments, various numbers of press units may be employed.

The printing press 120 may be configured to accommodate wide webs, such as webs around 75 inches in width. In various applications, wider or narrower webs may be used, as appropriate for the application. The ink used by printing press 120 may be specifically formulated to withstand the heat encountered by the printed substrate B during subsequent processing, such as a high-speed corrugation process.

The ink may be dried or cured onto the printed front substrate B in a variety of ways depending on the formulation of the ink to be used by the printing press 120. In some embodiments, the printing system 100 may be configured to allow the ink to dry via absorption and/or evaporation, by providing sufficient time in acceptable conditions. In various embodiments, the printing system 100 may comprise a curing component 130 to assist in the setting of the ink. In various embodiments, the curing component 130 may dry the ink used by the printing press 120 to print the substrate B. In some embodiments, curing component 130 may aid the evaporation and/or absorption of the ink from and/or into the printed substrate B. In other embodiments, curing component 130 may be configured to heat cure, UV cure the ink, or cure the ink by some other mechanism.

In various embodiments, the printing system 100 may further comprise one or more coating applicator components 160. In such embodiments, the coating applicator component 160 is configured to apply a coating to the printed substrate B. In some embodiments, the applied coating may be configured to protect the ink from degradation or smearing due to the heat used in high-speed corrugation applications. In other embodiments, the applied coating may be configured to protect the printed paperboard of a finished box from visible wear. In some embodiments, the applied coating may be configured to provide the printed substrate B with a semi-gloss, gloss, high gloss, or other finish. In the illustrated embodiment of FIG. 1, the first one of the coating applicator components 160 could apply an aqueous coating, and the successive coating applicator component 160 could apply a UV coating.

In embodiments of the printing system 100 comprising coating applicator components 160, the printing system 100 may further comprise coating drying components 140 and 150. In such embodiments, the coating drying components 140 and 150 may be configured to dry the coatings. In other such embodiments, the coating drying components 140 and 150 may be configured to cure the coating via heat curing, UV curing, or some other curing mechanism. In some embodiments, ink curing component 130 and coating drying components 140 and 150 may be implemented as a single component located downstream from the coating applicator component 160. Some embodiments of the offset printing system 100 may not comprise a coating drying component 140/150.

In various embodiments, such as the embodiment illustrated in FIG. 1, one or more web feeder devices may be configured to control the tension in the printed substrate B as the web is fed through the printing system 100. In various embodiments, the web feeder device may take a variety of forms, depending on the application. After the coating drying components 140 and 150, the printed, cured, and possibly coated substrate B may then be fed to rewinding component 170. The rewinding component 170 is configured to roll the printed substrate B onto roll 180 such that the printed substrate B may be used in later processes, such a high-speed corrugation system. However, it is not necessary that the printed substrate B be rewound, and it could be fed inline in web form to later processes.

### Bulk Ink Supply System 200

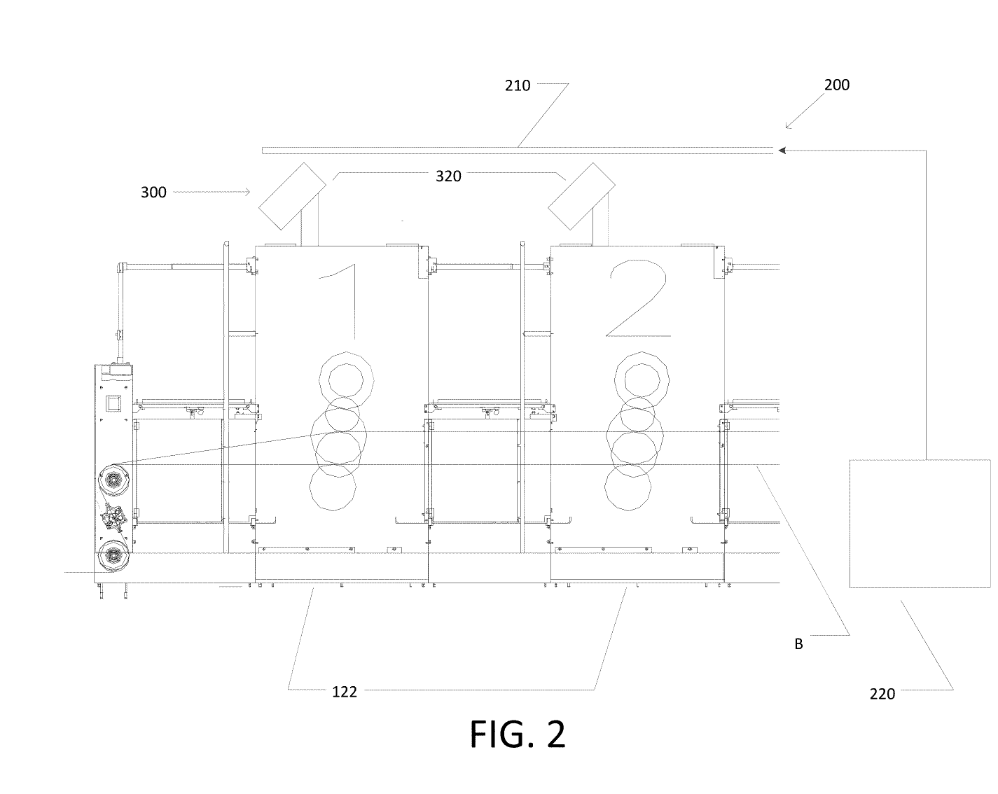

FIG. 2 is an enlarged view of a portion of FIG. 1 showing the first two of the seven press units 122. Each of the press units is adapted to print a layer of colored ink onto the substrate B as it is being printed. As more layers of ink are printed to the substrate B, which layers of ink may or may not overlap with prior layers of ink, the desired image is gradually formed until the final image emerges from the last press unit.

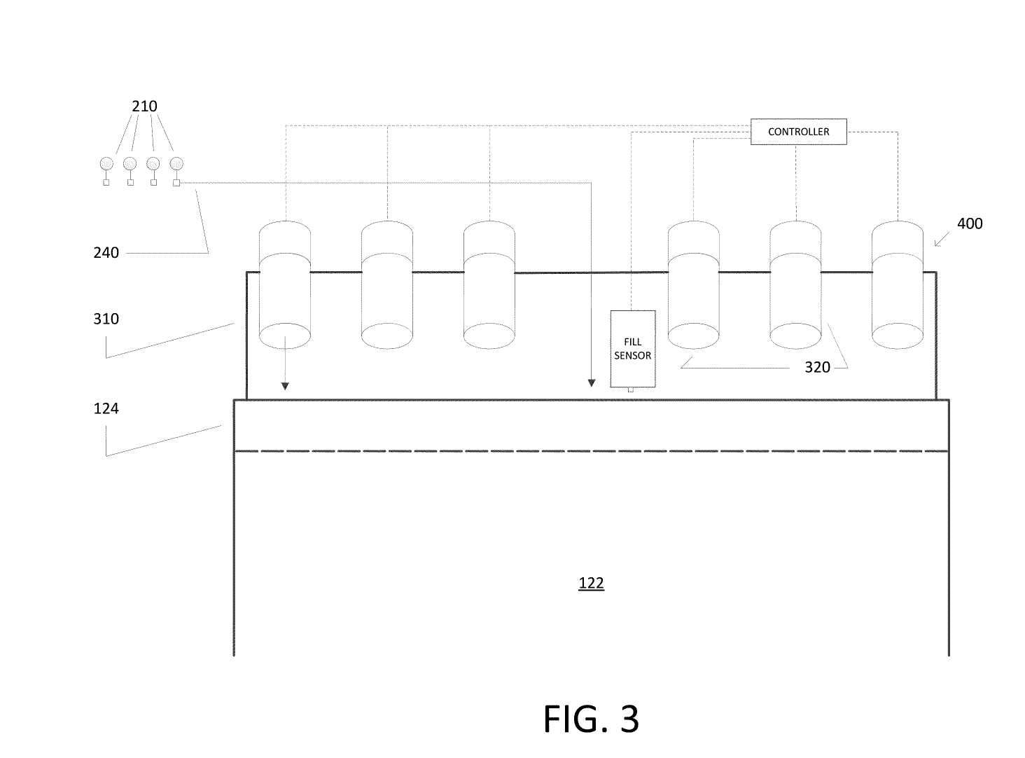

The bulk ink supply system 200 can include one or more supply lines 210. These supply lines 210 supply individual color inks to the press units 122. As shown in FIG. 3, four supply lines 210 can be provided to supply each of the primary black, cyan, magenta and yellow color inks to the press units 122. However, it is not necessary to use four supply lines, and more or fewer supply lines could be used depending on the number of colors to be used and/or the volume of ink to be supplied according to embodiments of the invention. In addition, although it may be more advantageous to supply only one ink color through each supply line, the particular color ink being supplied through that supply line may be changed. In such cases, it may be desirable to flush the supply line of the prior ink color before supplying the new ink color so as to avoid color contamination of the ink.

The bulk ink supply system 200 can further include one or more bulk hoppers 220 for storing a bulk supply of ink to be used in the printing process. Although only one bulk hopper 220 is shown in FIG. 2, multiple bulk hoppers could be provided with each bulk hopper containing an ink color corresponding to a supply line 210. The bulk hoppers may be portable so that inks can be precisely formulated at another location, such as a color laboratory, and then shipped to the printing press location. In other embodiments, the bulk hoppers could be fixed units in which the desired ink colors are formulated directly.

The ink in the bulk hoppers 220 is supplied to the corresponding supply lines, as is shown schematically in FIG. 2. One or more pumps (not shown) may be provided to ensure that the ink is adequately supplied to the press units 122, which may be necessary in the case of long distances from the bulk hoppers to the press units and/or the use of especially viscous inks In some embodiments, gravity may be used to cause the ink to be supplied to the supply lines 210, in which case the bulk hoppers 220 would be mounted above the press units 122.

Conventional press units 122 typically include an ink fountain 124 for receiving inks This ink fountain 124 is typically located near the top of the press unit 122 and includes one or more rolls (not shown) at the bottom of the ink fountain. The ink may be supplied to the ink fountain 124 in sufficient quantities to wet the bottom of the ink fountain, and the rolls are rotated to meter the ink and supply it to the ensuing rolls and equipment of the press unit so that it can be printed onto the substrate. However, embodiments of the ink supply systems according to the invention do not require an ink fountain and other ink infeed systems of printing presses could be used.

As seen in FIG. 3, the bulk ink supply system 200 can further include at least one connection line 240 for connecting the supply lines 210 to the ink fountain 124. According to embodiments of the invention, the connection line 240 includes a flexible hose having a connector on one end of the hose for connecting to one of the supply lines 210. Each of the supply lines 210 can be fitted with a corresponding connector adjacent to each of the press units 122. The other end of the hose can be clamped to a frame 310 mounted above the press unit 122. Thus, ink of one color is supplied from the bulk hopper 220, through a supply line 210, through the connected connection line 240 and directly into the ink fountain 124. In some embodiments, only one color of ink is supplied from one supply line 210 to the ink fountain 124 of one press unit 122, with others of the supply lines supplying ink to connection lines and ink fountains of others of the press units. As such, each of the seven illustrated press units 122 could receive a different single color of ink from the supply lines 210, or multiple press units may receive the same color ink, depending on the intended final print image.

In order to change the ink color supplied to any one press unit 122, the connection line 240 can be disconnected from the connected supply line 210 and reconnected to another supply line. A connection line comprising a flexible hose is relatively easy to flush and clean between connection operations, and could even be disposable and used only one time. In other embodiments, each of the supply lines 210 could have a dedicated connection line 240 extending between the supply line and the ink fountain 124 or have a dedicated connection line 240 extending from the supply line end that merges with one of more other connection lines before being routed into the ink fountain 124. Also, according to embodiments, the connection line 240 could be a rigid connection line formed of pipe or the like, and the removable connections may be replaced with permanent connections.

### Supplemental Ink Supply System 300

The supplemental ink supply system 300 can include one or more canisters 320 for supplying ink to each of the press units 122. As illustrated in FIG. 3, each of the press units 122 may have six canisters 320 mounted to the frame 310 over the respective press unit. Other embodiments may include fewer or more canisters for each press unit, and not all of the press units may be provided with canisters. Each of the canisters 320 on the frame 310 can be positioned to dispense ink directly from the canister into the ink fountain 124.

The canisters 320 can be disposable units formed of a tube of rigid paperboard or plastic. At one end an opening or a nozzle is provided for dispensing the ink, and the opening or nozzle may be provided with a removable cap that can be reinstalled when a canister is to be stored. At the other end of the canister a movable end wall may be provided that can act as a piston for pushing the ink through the nozzle. In one example, the ink canisters weigh approximately 8 lbs. In another example, the ink canisters weigh approximately 12 lbs. The term “canister” as used herein can include any other disposable and/or refillable containers including cartridges, bags, pouches, cans, tubes, bottles and/or the like.

The canisters 320 are prefilled with ink of a desired color. In particular, the ink color can be a specialty color other than the ink colors supplied by the bulk ink supply system 200. This specialty color may be a unique brand color for a customer for the printed substrate, such as a purchaser of corrugated boxes faced with a linerboard printed with the unique brand color. The specialty color ink may be formulated by a color laboratory commissioned by the customer and shipped to the printing press location in the canisters 320. In addition to specialty colors, the inks may be formulated to be fluorescent and/or iridescent, and/or mixed with additives such as metallic flakes, glitter, texturing agent, and/or the like for a unique appearance.

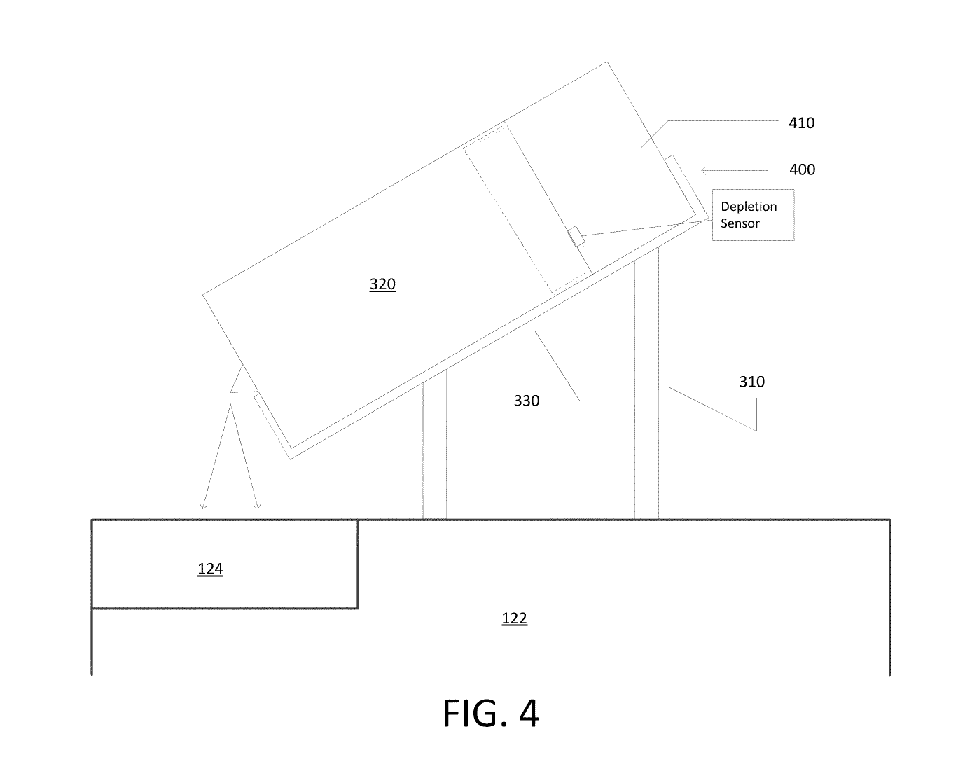

As seen in FIG. 4, the frame 310 includes one or more upright members and a support 330 for supporting each canister 320. The support 330 could have any number of configurations and orientations according to embodiments of the invention, but as illustrated comprises an open receptacle configuration on which the canister 320 can be placed in a tilted configuration with the nozzle facing downwardly. An operator can replace a depleted canister 320 with a full canister (with the same, or a different, color ink) during a printing operation.

According to embodiments, a dispense system 400 is provided for controllably dispensing ink from the canister 320. The dispense system 400 may include an actuator 410 that, when actuated, causes ink to be dispensed from the canister 320. According to embodiments, the actuator 410 includes a supply of pressurized air that causes the movable end wall of the canister 320 to move along the canister and force the ink through the nozzle and into the ink fountain 124 to dispense the ink. In various embodiments, a fitting is provided on the support 330 that fits over the upper end of a canister 320 to define a chamber, and the supply of pressurized air is connected to the fitting so as to pressurize the chamber and cause the movable end wall to move inside the canister and dispense ink therefrom. The actuator 410 could take other forms including a plunger and a linear motor, pneumatic motor or the like that can push the plunger into the canister. However, other dispense systems could be used, including pumps or gravity fed dispensers where a valve is controllably actuated to allow ink to be dispensed from the canister.

Further, the dispense system 400 may include one or more depletion sensors for sensing when the ink of a canister 320 is at least partially depleted and the volume of ink in the canister 320 is below a certain level, such as below 20%, 15%, 10%, or 5% full, or when the canister is completely empty. The depletion sensor may also be able to sense how much ink remains in the canister 320 before it is completely depleted, and/or how much ink has been dispensed therefrom. The depletion sensor may be provided besides or adjacent the canister 320 to sense directly how much ink has been depleted from the canister and/or remains in the canister. The depletion sensor may additionally, or alternatively, indirectly sense the amount of ink depleted from or remaining in the canister based on a parameter of the actuator 410 and/or the movable end wall. As illustrated, an ultrasonic sensor may be provided in the fitting to sense the distance from the fitting to the movable end wall and thus send a signal to a controller (discussed below) indicative of the amount of ink depleted from the canister.

In various embodiments, the supplemental ink system 300 (e.g., the frame 310) may be configured such that when a canister 320 is in use, the canister is in an upright, such as vertical, position. In some embodiments, all canisters 320 are in an upright position when the press 120 is in operation. In other embodiments, only a canister 320 from which ink is currently being dispensed is in the upright position. In yet other embodiments, a canister 320 may be in the upright position even if ink is not currently being dispensed from the canister. In various embodiments, the supplemental ink system 300 (e.g., the frame 310) may be configured to disengage and/or cause a canister 320 to tilt back away from upright. For example, the canister 320 may be disengaged and/or tilted back when the press 120 is not currently in operation, after a level sensor associated with the canister determines/senses that the ink in the canister is depleted (e.g., when the canister is empty or below a selected level), and/or the like. When a canister 320 is in the disengaged and/or tilted back position, an operator may be able to change out the canister for a new canister and/or access the unit for cleaning or maintenance.

### Intermediate Ink Supply System 500

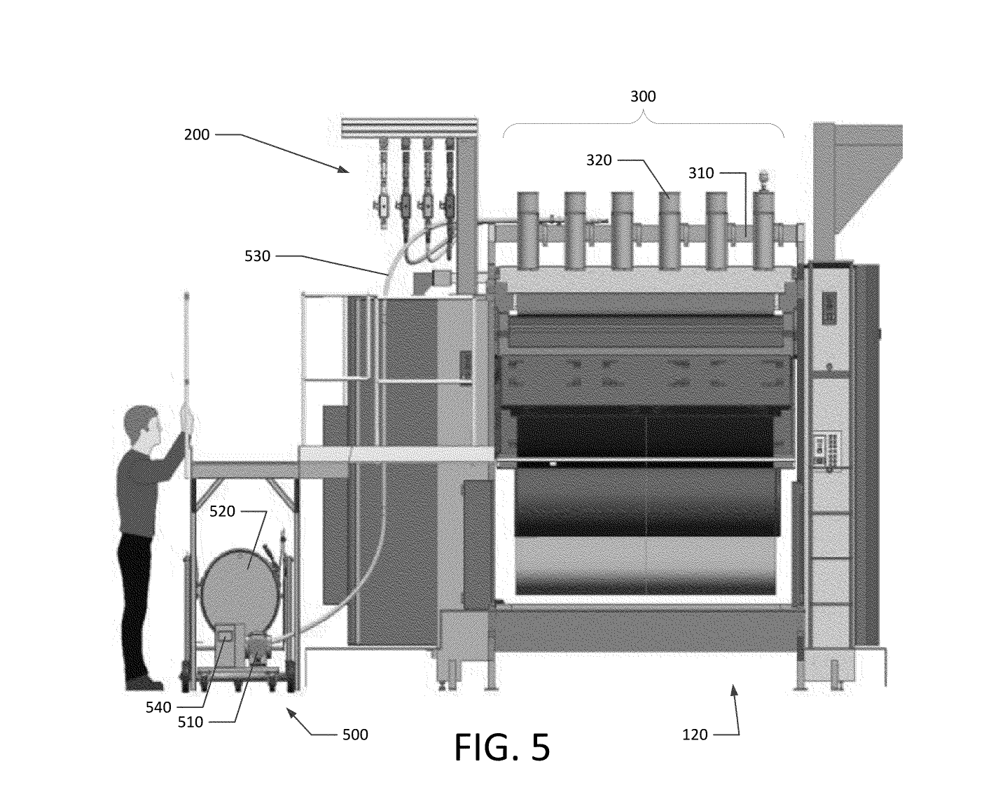

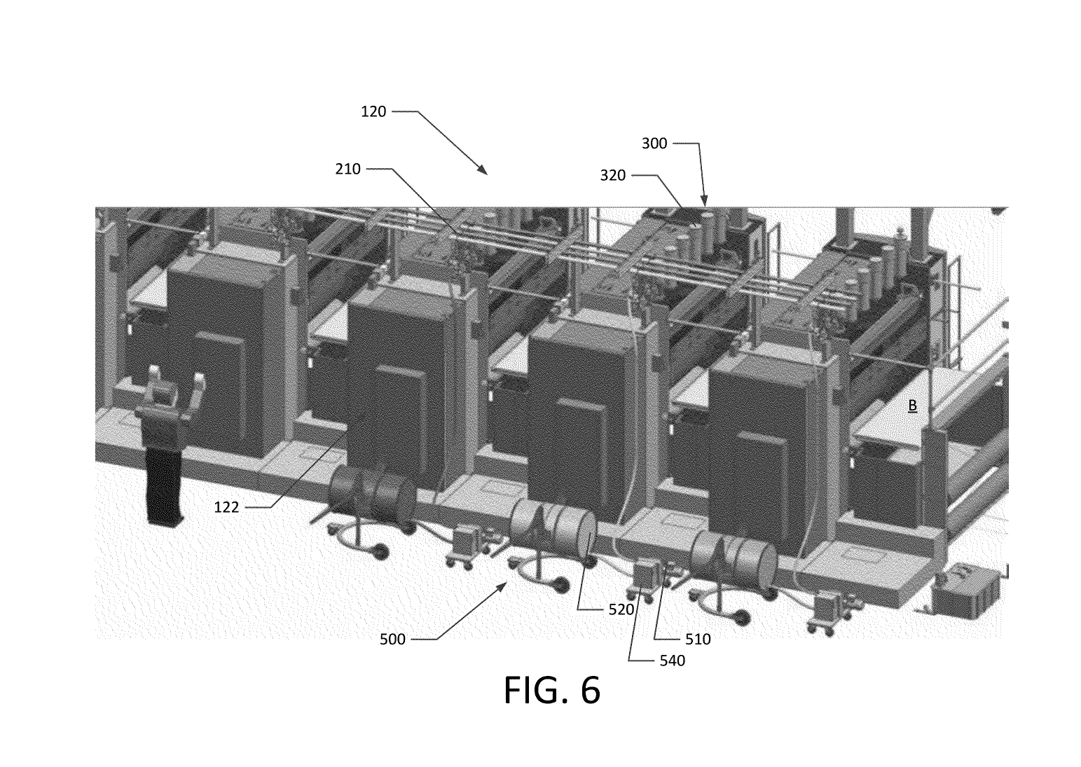

As illustrated in FIGS. 5 and 6, in various embodiments, a printing press 120 may comprise an intermediate ink supply system 500 configured to provide ink to one or more press units 122. The intermediate ink supply system 500 may be used in addition to and/or in place of a bulk ink supply 200 and/or a supplemental ink system 300. In some embodiments, a printing press 120 may comprise a bulk ink supply system 200, an intermediate ink supply system 500, and a supplemental ink supply system 300.

The intermediate ink supply system 500 may be configured to provide ink to one or more press units 122 from a barrel 520. The term “barrel” as used herein can include any other large refillable containers including drums, vats, tubs and/or the like. As illustrated, the barrels are 400 pound barrels, but other sizes can be used including barrels that are larger than canister 320 and smaller than bulk hopper 220. In various embodiments, the ink from the barrel 520 may be pumped through hose 530 into the ink fountain 124 by pump 510. In some embodiments, the pump 510 is a peristaltic pump, which is particularly advantageous when using viscous inks In various embodiments, a pipe may be used in place of hose 530. In particular embodiments, the pump 510 may be configured such that the pump need not be cleaned when the color ink pumped by the pump is changed.

In various embodiments, the barrel 520 or pump 510 may comprise a depletion sensor configured to monitor the fill level of the barrel and/or determine/identify when the barrel is at least partially depleted, such as when the fill level of the barrel is below 20%, 15%, 10%, or 5% full, or when the barrel is completely empty. For example, the depletion sensor may be a pressure sensor, float sensor, and/or the like positioned within the barrel 520 or along the ink pathway. In various embodiments, the depletion sensor may be configured to communicate with a controller (e.g., intermediate ink supply system controller 540). For example, if the fill level of the barrel reaches or falls below a predetermined level, the depletion sensor may transmit a signal to the controller indicating that the fill level has reached or fallen below the predetermined level. In some embodiments, the controller may be configured to alert an operator (e.g., cause a visual, sound, haptic, or other alert to be activated).

The barrel 520 is prefilled with ink of a desired color. In particular, the ink color can be a specialty color other than the ink colors supplied by the bulk ink supply system 200. This specialty color may be a unique brand color for a customer for the printed substrate, such as a purchaser of corrugated boxes faced with a linerboard printed with the unique brand color. The specialty color ink may be formulated by a color laboratory commissioned by the customer and shipped to the printing press location in the barrel 520. In addition to specialty colors, the inks may be formulated to be fluorescent and/or iridescent, and/or mixed with additives such as metallic flakes, glitter, texturing agent, and/or the like for a unique appearance. The ink provided via the intermediate ink supply system 500 may be a specialty ink used in a large run, a specialty ink with a significant coverage percentage, and/or the like. The intermediate ink supply system 500 could further be used to provide standard ink colors (e.g., black, magenta, cyan, yellow, and/or the like).

In various embodiments, the intermediate ink system 500 may be configured to reduce the need for intervention by an operator. In particular, for printing jobs that require a large amount of specialty ink colors, the intermediate ink system 500 can be used in combination with the supplemental ink system 300 and use the same color scheme such that each press unit 122 receives the same color ink from both the intermediate ink system and the supplemental ink system.

### Controller and Operation

As shown in FIG. 3, a fill sensor may be supported over the ink fountain 124 to sense the level of the ink available for use by the printing press in the ink fountain 124. If the level of the ink in the ink fountain is too low to ensure complete coverage for the image to be printed on the substrate, the fill sensor senses the deficiency and sends a signal indicative of the deficiency to a controller. Although one fixed fill sensor is illustrated, embodiments of the invention include multiple fill sensors located at various locations adjacent the ink fountain 124. Further, one or more fill sensors may be mounted on movable carriages for moving about the ink fountain 124 such as, for example, along a rail supported by the frame 310. The fill sensors can operate according to various physical principles including ultrasonic sensors, optical sensors, conductivity sensors, float switch sensors, magnetic float level sensors, capacitance level sensors, hydrostatic pressure level sensors, pneumatic level sensors, or the like.

The controller may be provided for controlling the various operations of the ink supply systems. The controller may comprise any type of controller usable for controlling industrial operations including programmable logic controllers (PLCs), PC-based controllers, microprocessor-based controllers, safety programmable controllers, or the like. The controller may also be connected to the actuators 410 and depletion sensors of the dispense systems 400 for controlling when to dispense ink from certain of the canisters 320. The controller may further be connected to the pumps 510 and depletion sensors for providing ink via the intermediate ink supply system 500 and to any pumps or sensors used in connection with the bulk hoppers 220. In addition, the controller may be connected to any fill sensors and dispense systems 400 associated with other press units 122 of the printing system 100.

In operation, the fill sensor provides a signal indicative of when the ink is low and the controller may then control one or more of the dispense systems 400 to dispense ink from an associated canister to refill the ink fountain 124 to at least a selected amount. The selected amount may be determined based on, for example, on a desired percentage of the volume or height of the ink fountain 124. However, the selected amount may vary according to the printing job and may be adjusted by the press operator before and/or during the printing job based at least in part on experience and visual observation. Thus, it is not necessary that the selected amount be predetermined or determined according to mathematical calculations. The fill sensor may provide only a signal indicative that the ink is low, or may in addition provide a signal to the controller indicative of the quantity of additional ink that is needed. In addition, the illustrated fill sensor, and/or additional sensors, may sense when the ink level is too high in the ink fountain 124, and send an indicative signal to the controller to stop the dispensing from the canisters 320. Further, the controller may be connected to a controller for the overall printing system 100 so that the supplemental ink supply system 300 will only operate when the printing process is operating.

According to embodiments of the invention, the canisters 320 can all be filled with the same specialty color ink. For high speed and/or long printing runs, the multiple canisters provide sufficient specialty color ink for completing the printing run. This is an advantage over single canister systems that would require frequent replacement of the canister by an operator for high speed and/or long printing runs. Although the canisters are described herein as containing specialty ink colors, the canisters could be filled with the colors of the bulk ink supply system 200, such as black, cyan, magenta or yellow. As such, the supplemental ink supply system 300, according to embodiments, can act as a supplemental system for supplying specialty color inks, or as a supplemental system for supplying more of the same color ink as the bulk supply system, and thus provides more production flexibility to the printing system 100.

The controller can sequence the dispense systems 400 so that ink is dispensed from the canisters 320 one at a time. If a printing run requires less ink than the total volume of ink in the canisters associated with a press unit, then the unused canisters can be removed and stored for a later printing run. This is advantageous over a system where all of the canisters can only dispense at once, as all of the canisters might be only partially depleted in the case of a short printing run, and the remaining ink would be wasted. In embodiments where only one canister, or some other subset of the total number of canisters, is being dispensed, a sweep may be provided in the ink fountain 124 that shuttles back and forth along the ink fountain to ensure adequate ink coverage along the length of the ink fountain. Although the controller can sequence the dispensing one canister at a time, it could also sequence two, three or more canisters at a time depending on the expected printing run or other factors. Indeed, the controller could control the dispense systems 400 to dispense ink from all of the canisters at once should the printing run be sufficiently long or a high volume of ink is required.

In various embodiments, the intermediate ink supply system 500 may also be in communication with the controller. In other embodiments, the intermediate ink supply system 500 may be in communication with an intermediate ink supply controller 540, which may be similar to the controller discussed above and in communication therewith. In various embodiments, the fill sensor provides a signal indicative of when the ink is low and the intermediate ink supply system controller 540 may then control one or more components of the intermediate ink supply system 500 (e.g., pump 510) to dispense ink from the barrel 520 to refill the ink fountain 124 to a desired level. The fill sensor may provide only a signal indicative of the ink being low, or may in addition provide a signal to the controller indicative of the quantity of additional ink that is needed. In addition, the illustrated fill sensor, and/or additional sensors, may sense when the ink level is too high in the ink fountain 124, and send an indicative signal to the intermediate ink supply system controller 540 to stop the dispensing from the barrel 520. Further, the intermediate ink supply system controller 540 may be connected to a controller for the overall printing system 100 so that the intermediate ink supply system 500 will only operate when the printing process is operating. In embodiments, all of ink supply systems 200, 300, 500 and the printing system 100 may be controlled by one controller.

As noted above, the intermediate ink supply system 500 may comprise one or more depletion sensors configured to provide an indicative signal to the controller when the fill level of ink in the barrel 520 is at least partially depleted. The controller may be configured to alert an operator that the fill level of the barrel 520 has reached or fallen below the predetermined level (e.g., cause a visual, sound, haptic, or other alert to be activated).

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An ink supply system for a printing press comprising:
a bulk ink supply system, wherein the bulk ink supply system comprises one or more supply lines leading to the printing press for supplying ink to the printing press in bulk and wherein each of the supply lines supplies a single ink color; and
a supplemental ink supply system, wherein the supplemental ink supply system comprises one or more ink canisters for supplying ink to the printing press.

2. An ink supply system according to claim 1 wherein the bulk ink supply system further comprises a connection line for supplying ink from at least one of the supply lines to the printing press.

3. An ink supply system according to claim 2 wherein at least one connection line comprises a flexible hose connectible to a supply line.

4. An ink supply system according to claim 1 further comprising a frame on which the one or more ink canisters are mounted.

5. An ink supply system according to claim 4 wherein the bulk ink supply system further comprises a connection line for supplying ink from at least one of the supply lines to the printing press, wherein the at least one connection line comprises a flexible hose, and wherein at least one end of the flexible hose is supported on the frame adjacent one or more of the ink canisters.

6. An ink supply system according to claim 1 wherein the bulk ink supply system comprises at least four supply lines.

7. An ink supply system according to claim 6 wherein at least one supply line supplies one of black, cyan, magenta or yellow ink colors.

8. An ink supply system according to claim 1 wherein the printing press comprises a plurality of printing press units, and wherein at least one of the printing press units is supplied with a supplemental ink supply system comprising one or more ink canisters.

9. An ink supply system according to claim 8 wherein the supplemental ink system comprises a plurality of ink canisters.

10. An ink supply system according to claim 9 wherein the supplemental ink system comprises at least 6 ink canisters.

11. An ink supply system according to claim 9 wherein the plurality of ink canisters of a supplemental ink supply system supply ink of the same color to the at least one printing press unit.

12. An ink supply system according to claim 1 wherein the ink color of the bulk ink supply system is different from the ink color of the supplemental ink supply system.

13. An ink supply system according to claim 1 wherein at least one of the ink canisters supplies ink of a color other than black, cyan, magenta and yellow.

14. An ink supply system according to claim 1 wherein at least one of the ink canisters supplies ink of one of black, cyan, magenta and yellow colors.

15. An ink supply system according to claim 1 wherein a substrate to be printed comprises a linerboard web having a basis weight of approximately 23 to 55 pounds per 1000 square feet.

16. An ink supply system for a printing press comprising:
a bulk ink supply system, wherein the bulk ink supply system comprises one or more supply lines leading to the printing press for supplying ink to the printing press in bulk;
a supplemental ink supply system, wherein the supplemental ink supply system comprises one or more ink canisters for supplying ink to the printing press; and,
an intermediate ink supply system, wherein the intermediate ink supply system comprises one or more barrels for supplying ink to the printing press.

17. The ink supply system of claim 16 wherein each barrel is configured to hold a larger volume of ink than the volume of ink held in at least one of the ink canisters.

18. The ink supply system of claim 16 further comprising at least one depletion sensor for providing a signal indicative of when the ink in at least one barrel is at least partially depleted.

19. The ink supply system of claim 16 further comprising a peristaltic pump for pumping the ink from the barrel to the printing press.

20. An ink supply system according to claim 16 wherein at least one of the barrels supplies ink of a color other than black, cyan, magenta and yellow.

21. An ink supply system for a printing press unit comprising:
a plurality of ink canisters arranged adjacent to a printing press unit for supplying ink to the printing press unit, wherein the ink canisters contain ink of a single color;
a plurality of dispense systems associated with one or more of the ink canisters, each dispense system comprising,
an actuator causing ink to be selectively dispensed from an associated ink canister when the actuator is actuated, and
a depletion sensor for sending a signal indicative of when the ink in the ink canister is at least partially depleted; and,
a controller in operative communication with the dispense systems and adapted for causing at least one actuator to dispense ink from a subsequent one or more of the ink canisters when the depletion sensor sends a signal that the ink in a preceding ink canister is at least partially depleted.

22. An ink supply system according to claim 21 further comprising a fill sensor for sending a signal indicative of the amount of ink available for use by the printing press unit, wherein the fill sensor is in operative communication with the controller.

23. An ink supply system according to claim 21 wherein the ink supply system comprises at least six ink canisters.

24. An ink supply system according claim 21 further comprising at least one support for supporting the ink canisters, wherein the support is structured to allow a depleted canister to be removed from the support and be replaced with a new ink canister.

25. An ink supply system according to claim 21 wherein at least one of the dispense systems actuators comprises a supply of pressurized air.

26. An ink supply system according to claim 21 wherein the ink supply system is configured to operate with offset printing presses able to accommodate substrates at least approximately 75 inches in width.

27. An ink supply system according to claim 21 wherein a substrate to be printed comprises a linerboard web having a basis weight of approximately 23 to 55 pounds per 1000 square feet.

28. An ink supply system for a printing press comprising:
at least one barrel arranged adjacent to a printing press for supplying ink to the printing press;
a dispense system associated with each barrel, each dispense system comprising
a pump causing ink to be selectively dispensed from an associated barrel when the pump is actuated, and
wherein the pump is a peristaltic pump.

29. A method of supplying ink to a printing press comprising the steps of:
supplying bulk ink from a bulk ink supply system to the printing press, wherein the bulk ink supplying step comprises supplying ink through one or more supply lines to the printing press; and
supplying supplemental ink from a supplemental ink supply system to the printing press, wherein the supplemental ink supplying step comprises supplying ink to the printing press from one or more ink canisters.

30. A method of supplying ink according to claim 29, further comprising supplying ink of the color black, cyan, magenta or yellow through at least one of the supply lines.

31. A method of supplying ink according to claim 29, further comprising supplying ink of a color other than black, cyan, magenta or yellow through the supplemental ink supply system.

32. A method of supplying ink according to claim 29 further comprising supplying ink from an intermediate ink supply system to the printing press, wherein the step of providing ink from an intermediate ink supply system.

33. A method of supplying ink according to claim 32, wherein the step of providing ink from an intermediate ink supply system further comprises supplying ink to the printing press from one or more barrels by pumping the ink out of the barrel using a peristaltic pump.

34. A method of supplying ink to a printing press unit comprising:
actuating a dispense system to dispense from at least one of a plurality of ink canisters to a printing press unit;
sensing when the ink canister is at least partially depleted of ink; and, actuating another dispense system from a least one other ink canister to dispense ink into the printing press unit.

35. A method of supplying ink according to claim 34 wherein the step of actuating another dispense system further comprises dispensing ink of the same color as the ink of the previously at least partially depleted ink canister.

36. A method of supplying ink according to claim 35 further comprising the step of sensing when the printing press unit ink fountain has less than a selected amount of ink available for use.

37. A method of supplying ink according to claim 36 wherein the step of actuating another dispense system occurs after both the steps of sensing when the ink canister is at least partially depleted and sensing when the printing press unit ink fountain has less than a selected amount of ink available for use.
